(19) United States
(12) Patent Application Publication
(10) Pub. No.: US 2006/0209687 A1
(43) Pub. Date: Sep. 21, 2006

(54) Communication rate control method and device

(75) Inventors: Hirofumi Yagawa, Yokohama (JP); Masamichi Kasa, Yokohama (JP); Katsunori Mawatari, Yokohama (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/166,373

(22) Filed: Jun. 27, 2005

(30) Foreign Application Priority Data
Mar. 18, 2005 (JP) 2005-080666

(51) Int. Cl. H04J 3/22; H04L 12/26; H04L 1/00; H04J 3/16

(52) U.S. Cl. 370/229; 370/468

(57) ABSTRACT

A method of controlling the communication rate between a user terminal and an edge switch of a network is provided. This method includes the step of matching the transmission rate at which data is transmitted from the user terminal to the edge switch, with the communication rate of the edge switch that is determined under contract with a user.

### BACKGROUND OF THE INVENTION

The present invention generally relates to communication rate control methods and devices, and, more particularly, to a method and a device for controlling the communication rate between a user terminal and an edge switch of a network.

As the communication techniques and communication equipment have dramatically advanced recently, the volume of communication that utilizes IP (Internet Protocol) networks through apparatuses such as PCs (personal computers) is rapidly increasing, and more efficient communication methods are expected for data communication (PCs), voice data (IP telephone), and image data.

FIG. 1 illustrates the network structure of an IP network. As shown in FIG. 1, a wide area network 10 includes core switches 11 and edge switches 12, and provides communication services to user PCs. The core switches 11 are network switching devices that are located within the wide area network 10. Each of the edge switches 12 is a network switching device that connects user PCs 13 and 14 to the wide area network 10. The user PC 13 performs communication with the other user PC 14 through the Web or FTP over the wide area network 10.

FIG. 2 is a block diagram illustrating conventional user PCs and a conventional edge switch.

In a user PC 20 on the transmission side in FIG. 2, a packet generator 21 divides a file 22 to generate packets for communication, and stores the packets in a buffer 23. At the time of packet generation, a serial number for indicating the continuousness among the packets is allotted to each packet on the reception side.

A transmission controller 24 transmits the packets stored in the buffer 23. The transmission controller 24 also receives a reception response that is transmitted from a user PC on the reception side, and, when detecting a retransmission request in the response, performs a retransmitting operation. A shaper 25 controls the readout of the packets from the buffer 23 in accordance with the condition of the output line, so as to adjust the transmission volume (the transmission rate) of the transmission controller 24.

In the edge switch 30, a queue 31 awaits a receiving operation for input packets. A policer 32 monitors the number of input packets, and discards packets beyond the preset band (the user contract band). A switch unit 33 performs a transfer operation between core switches and the edge switch 60 in accordance with the destination of each packet. A buffer 34 stores the packets of each address sent from the switch unit 33. A shaper 35 controls the transmission volume in accordance with the condition of the output line.

In a user PC 40 on the reception side, a checking unit 41 monitors the number allotted to each packet on the transmission side, so as to check the continuousness of received packets. The checking unit 41 then notifies a response unit 42 of the check result. If there is a break in the continuousness of the packets, the checking unit 41 determines that a packet is missing, and notifies the response unit 42 of the number of the missing packet as well as the check result. If there is not a packet that is missing, a file 43 is reproduced from the received packets.

The response unit 42 generates a reception response from the check result supplied from the checking unit 41, and transmits the reception response to the user PC 20 on the transmission side. When a missing packet is detected, the number of the missing packet and a retransmission request are attached to the reception response to be transmitted to the user PC 20.

FIG. 3 shows the sequence of a retransmitting operation.

(A) The user PC 20 on the transmission side transmits generated packets at a line rate that is set between the user PC 20 and the edge switch 30. Normally, the preset band of the policer 32 of the edge switch 30 is set lower than the line rate, based on the user contract under which the user PC 20 is connected to the wide area network 10.

Accordingly, when communication beyond the preset band is performed, the policer 32 discards packets, and a retransmission request is made by the user PC 40 on the reception side. The user PC 20 on the transmission side monitors reception responses from the user PC 40 on the reception side. When receiving a retransmission request, the user PC 20 stops transmission, and waits a predetermined period of time (wait #1).

(B) After the transmission stop of “wait “1”, the user PC 20 on the transmission side resumes the transmission at the line rate, starting from the packet with the number specified in the transmission request. Here, the number of packets to be retransmitted is equal to the number of packets continuously transmitted until the discard. Upon receipt of a retransmission request after packet discarding, the user PC 20 on the transmission side estimates the line rate. The estimating method is described below.

If the transmission value (A) is greater than the transmission volume (B), the communication rate in the network 10 is low, and therefore, the next “wait #2” made longer than “wait #1”.

If the transmission volume (A) is equal to or smaller than the transmission volume (B), the communication rate of the network 10 is high, and therefore, the next “wait #2” is made smaller than “wait #1”.

The above operation is repeated so as to increase the usability (TCP congestion control, disclosed in “TCP Performance in IP Network”, the 57th Kyushu region convention of the IEE conference, Venue No. 10, 10-A2-01, Sep. 27 & 28, 2004).

Japanese Laid-Open Patent Application No. 7-123099 discloses a method of controlling a communication rate in an ATM multiplexer. Japanese Laid-Open Patent Application No. 10-285218 discloses a method of controlling a communication rate in a case where routers connected to two different networks are connected with a relay line.

By a conventional communication rate control method, however, packet discarding and retransmission are invariably caused during the stage of optimizing the communication rate or the band. Such packet retransmission reduces the network usability.

Also, the minimum value for the wait time depends on the performance of each PC. If the wait time is long with respect to the communication rate of the network 10, the queue 31 of the edge switch 30 becomes empty, resulting in a decrease in usability of the network 10.

### SUMMARY OF THE INVENTION

A general object of the present invention is to provide communication rate control methods and devices in which the above disadvantages are eliminated.

A more specific object of the present invention is to provide a communication rate control method by which packet discarding is not caused in the edge switch, the amount of packet retransmission under TCP congestion control is reduced, and the usability of the network is increased accordingly.

The above objects of the present invention are achieved by a method of controlling a communication rate between a user terminal and an edge switch of a network. This method includes the step of: matching the transmission rate at which data is transmitted from the user terminal to the edge switch, with the communication rate of the edge switch that is determined under contract with the user.

As the transmission rate of the user PC and the communication rate of the edge switch become equal to each other, packet discarding is not caused in the edge switch, the amount of packet retransmission under TCP congestion control is reduced, and the usability of the network is increased accordingly.

In the above method, the step of matching the transmission rate of the user terminal with the communication rate specified in the user contract can be carried out at the time of linkup to connect the user terminal to the network.

Also in the above method, the step of matching the transmission rate of the user terminal with the communication rate specified in the user contract may be carried out at regular intervals.

Also in the above method, the step of matching the transmission rate of the user terminal with the communication rate specified in the user contract may be carried out when the communication rate specified in the user contract with respect to the edge switch is changed.

Also in the above method, the step of matching the transmission rate of the user terminal with the communication rate specified in the user contract may be carried out by the user terminal, when a request to change the transmission rate is made.

The above objects of the present invention are also achieved by a user terminal that is used in conjunction with a method of controlling the communication rate between the user terminal and an edge switch of a network. This user terminal includes: an inquiring unit that inquires the communication rate of the edge switch that is determined under contract with the user; and a transmission rate control unit that matches the transmission rate at which data is transmitted to the edge switch, with the communication rate specified in the user contract that is notified by the edge switch.

In the above user terminal, the inquiring unit can make the inquiry to the edge switch at the time of linkup to connect the user terminal to the network.

Also in the above user terminal, the inquiring unit may make the inquiry to the edge switch at regular intervals.

The above objects of the present invention are also achieved by an edge switch that is used in conjunction with a method of controlling the communication rate between a user terminal and an edge switch of a network. This edge switch includes: a notifying unit that notifies the user terminal of the communication rate that is determined under contract with the user, in response to an inquiry from the user terminal.

In the above edge switch, the notification is sent to the user terminal when the communication rate specified in the user contract is changed.

In accordance with the present invention, packet discarding is not caused in the edge switch, the amount of packet retransmission under TCP congestion control is reduced, and the usability of the network is increased accordingly.

The above and other objects and features of the present invention will become more apparent from the following description taken in conjunction with the accompanying drawings.

### BRIEF DESCRIPTION OF THE DRAWINGS

FIG. 1 illustrates the network structure of an IP network;

FIG. 2 is a block diagram of conventional user PCs and a conventional edge switch;

FIG. 3 illustrates a retransmitting sequence;

FIG. 4 is a block diagram of user PCs and an edge switch in accordance with the present invention;

FIG. 5 illustrates an example of a band inquiring frame in accordance with the present invention;

FIG. 6 illustrates an example of a band notifying frame in accordance with the present invention;

FIG. 7 shows the operation sequence in accordance with a first embodiment of a communication rate control method of the present invention;

FIG. 8 shows the operation sequence in accordance with a second embodiment of a communication rate control method of the present invention;

FIG. 9 shows the operation sequence in accordance with a third embodiment of a communication rate control method of the present invention; and

FIG. 10 shows the operation sequence in accordance with a fourth embodiment of a communication rate control method of the present invention.

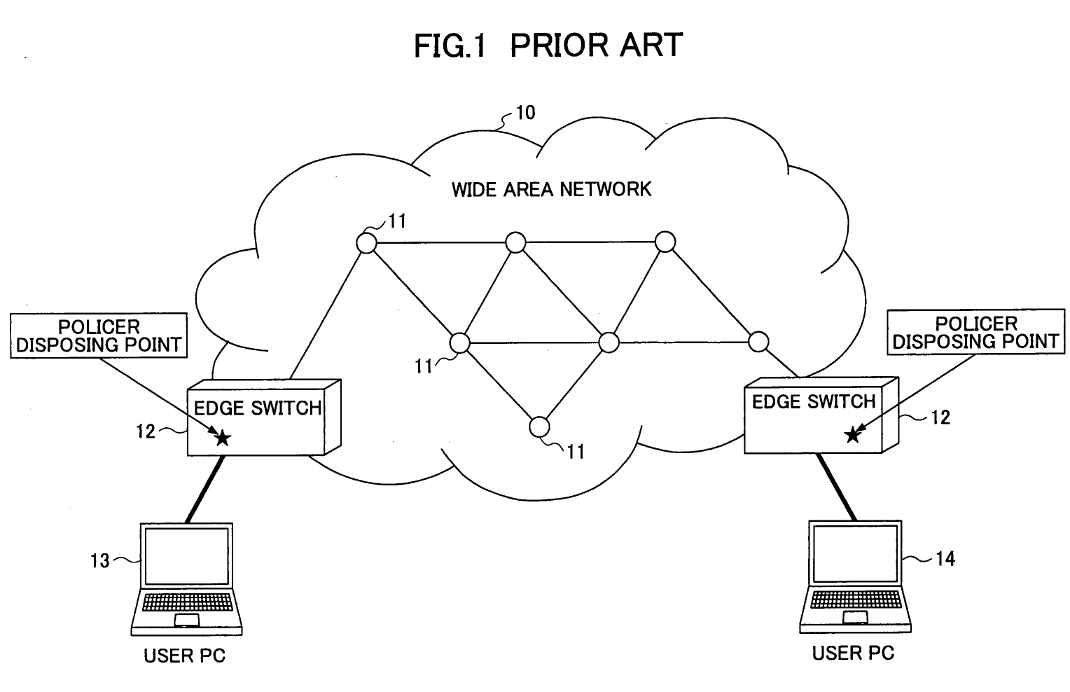

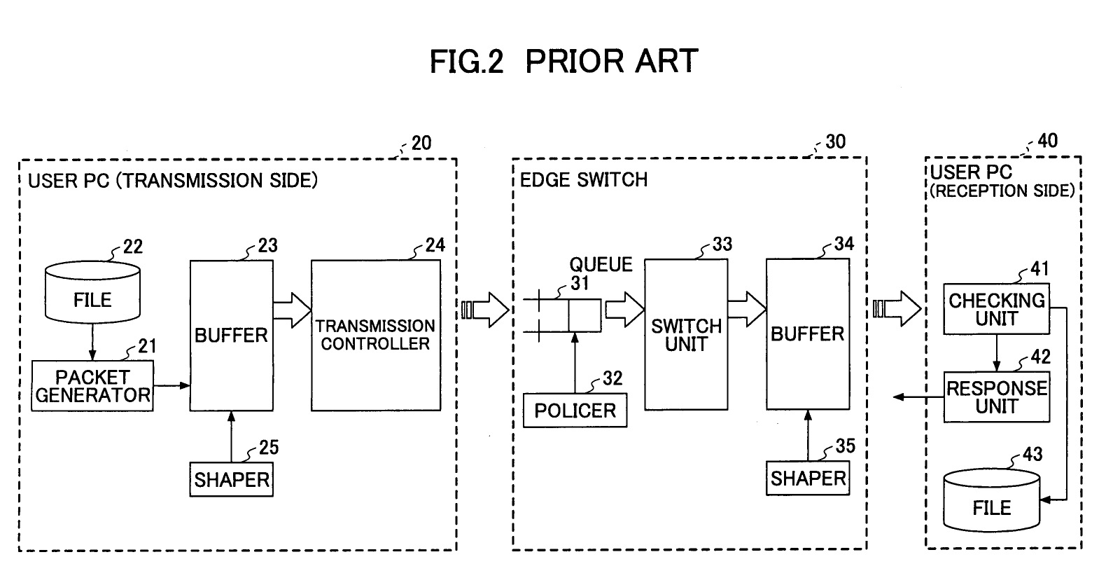

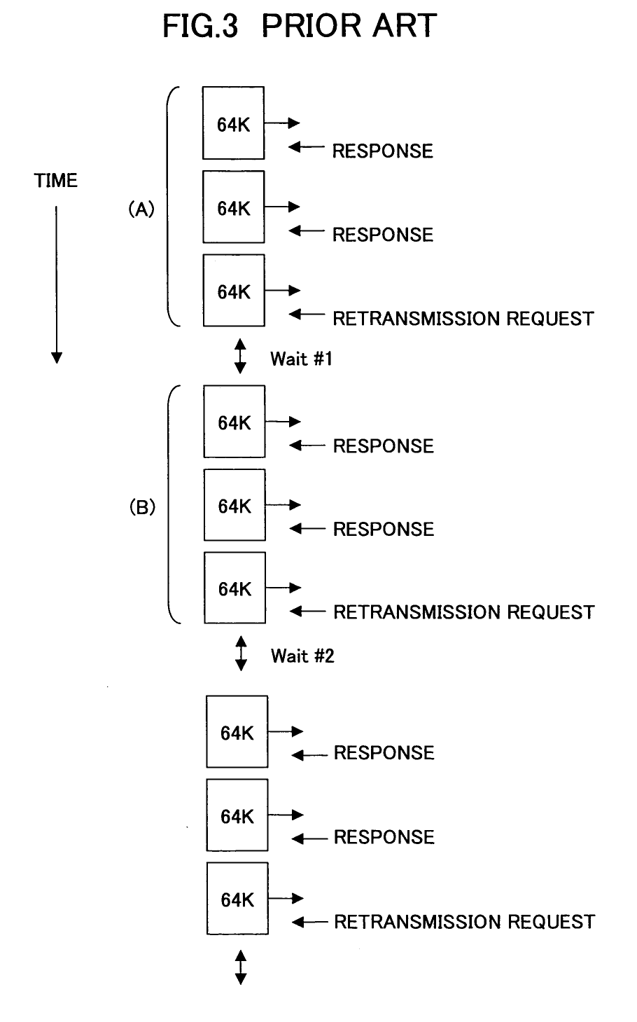

### DESCRIPTION OF THE PREFERRED EMBODIMENTS

The following is a description of embodiments of the present invention, with reference to the accompanying drawings.

<Structures of User PCs and Edge Switch>

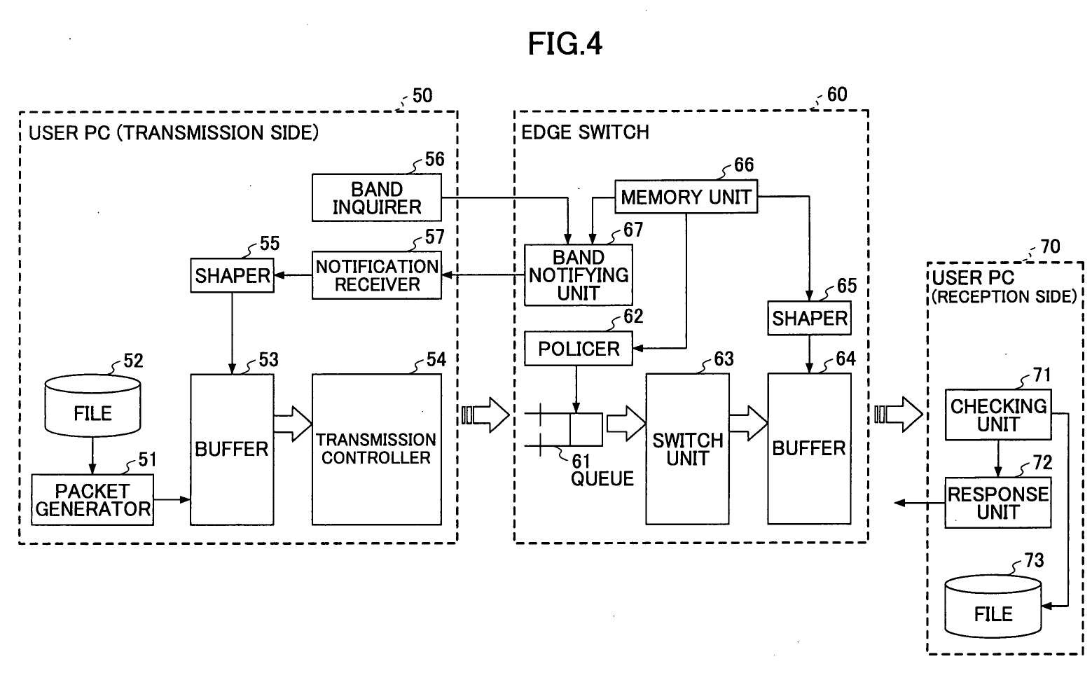

FIG. 4 is a block diagram illustrating one embodiment of user PCs and an edge switch in accordance with the present invention.

As shown in FIG. 4, in a user PC 50 on the transmission side, a packet generator 51 divides a file 52 to generate packets for communication, and stores the packets in a buffer 53. At the time of packet generation, a serial number for indicating the continuousness among packets is allotted to each packet on the reception side.

A transmission controller 54 transmits the packets stored in the buffer 53. The transmission controller 54 also receives a reception response that is transmitted from a user PC on the reception side, and, when detecting a retransmission request in the response, performs a retransmitting operation. A shaper 55 controls the readout of the packets from the buffer 53 in accordance with the condition of the output line, so as to adjust the transmission rate and the transmission band of the transmission controller 54.

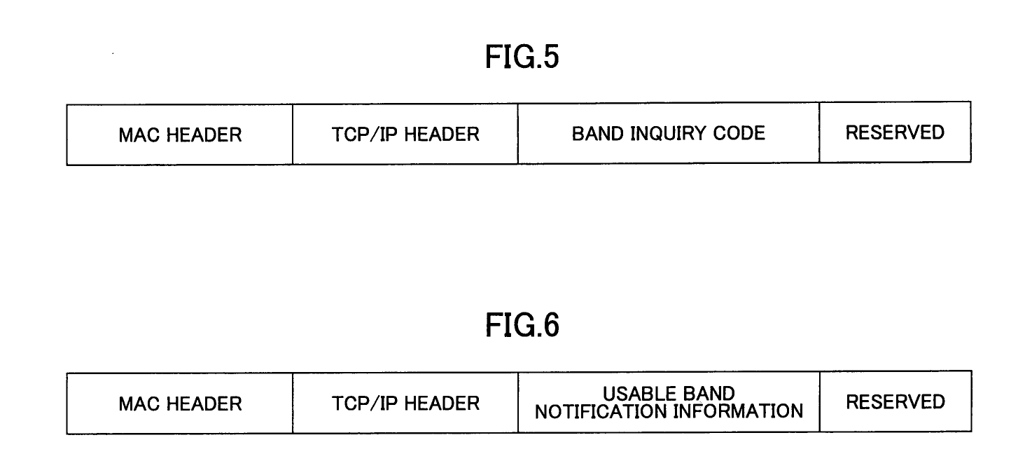

A band inquirer 56 inquires of an edge switch 60 the preset band (the user contract band or the communication rate to which the user has agreed under contract with a communication carrier) and the queue size with respect to the user PC 50. An example of the band inquiring frame to be used in the inquiring is shown in FIG. 5. The band inquiring frame includes a MAC header, a TCP/IP header, and a band inquiring code.

A notification receiver 57 receives the information as to the preset band (the preset band and the queue size) from the edge switch 60 in response to the preset band inquiry, and sends the preset band information to the shaper 55. As described later, the shaper 55 limits the amount of packet transmission from the user PC 50 to the edge switch 60, based on the received preset band.

In the edge switch 60, a queue 61 awaits a receiving operation for the received packets. The queue 61 can set a threshold value (a queue size). If a packet exceeding the threshold value is entered, the packet is discarded. A policer 62 monitors the number of input packets, and discards packets beyond the preset band (the user contract band) stored in a memory unit 66.

A switch unit 63 performs a transfer operation between core switches and the edge switch 60 in accordance with the destination of each packet. A buffer 64 stores the packets of each address sent from the switch unit 63. A shaper 65 controls the transmission rate in accordance with the condition of the output line.

In the memory unit 66, the preset band (the user contract band) of each of the user PCs connected to the device (which is the edge switch 60) and the queue size of the queue 61 are stored in advance. The preset band of the transmission path between the device and a core switch 11 of a wide area network 10, and the preset band of the transmission path between the device and another edge switch 12 are also stored in advance. The preset band of each user PC is set under contract.

In response to the preset band inquiry from the user PC 50, a band notifying unit 67 reads out the preset band with respect to the user PC 50 from the memory unit 66, and sends the preset band information to the user PC 50. An example of the band notifying frame to be used in this notification is shown in FIG. 6. The band notifying frame includes a MAC header, a TCP/IP header, and usable band notification information.

In a user PC 70 on the reception side, a checking unit 71 monitors the number allotted to each packet on the transmission side, so as to check the continuousness of received packets. The checking unit 71 then notifies a response unit 72 of the check result. If there is a break in the continuousness of the packets, the checking unit 71 determines that a packet is missing, and notifies the response unit 72 of the number of the missing packet as well as the check result. If there is not a packet that is missing, a file 73 is reproduced from the received packets.

The response unit 72 generates a reception response from the check result supplied from the checking unit 71, and transmits the reception response to the user PC 50 on the transmission side. When a missing packet is detected, the number of the missing packet and a retransmission request are attached to the reception response to be transmitted to the user PC 50.

### First Embodiment

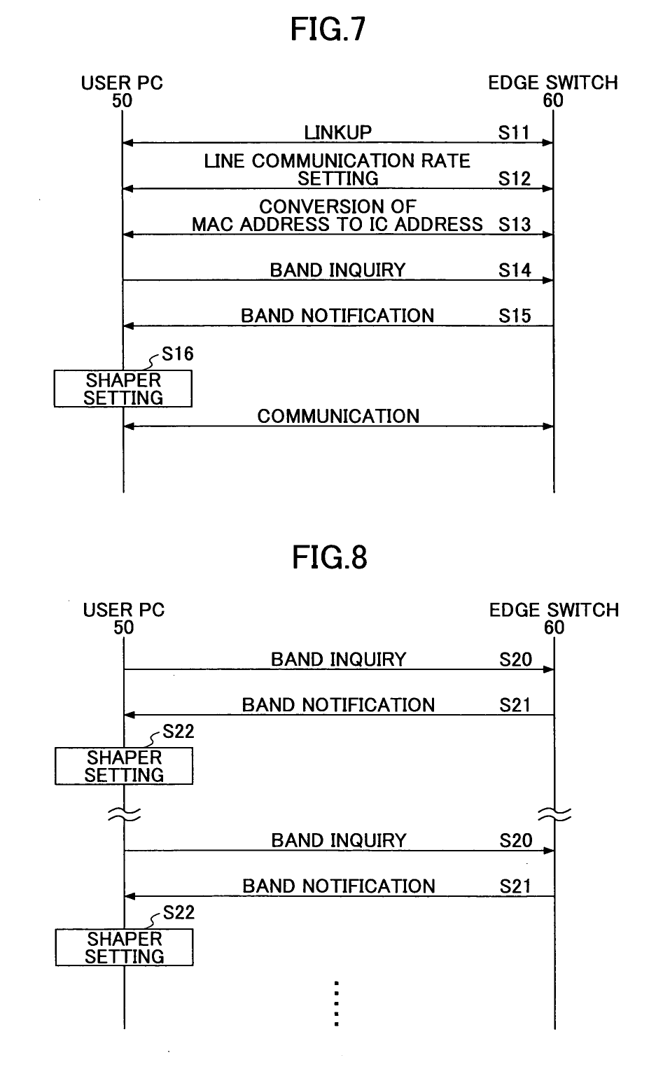

FIG. 7 shows the operation sequence in accordance with a communication rate control method as a first embodiment of the present invention. In FIG. 7, the user PC 50 performs physical and electric connection (linkup) with the edge switch 60 in step S11, and sets the communication rate (communication mode) of the line in step S12. The communication rate setting is carried out using an auto negotiation function to switch communication rates of the device in accordance with the inherent setting or the destination of the connection. In step S13, ARP (Address Resolution Protocol) is used to convert the MAC address and the IP address (address resolution).

Next, a band negotiation is performed. In step S14, the band inquirer 56 of the user PC 50 inquires of the edge switch 60 the preset band with respect to the device.

In response to that, the band notifying unit 67 of the edge switch 60 sends the band conditions (the preset band and the queue size) of the user PC 50 to the notification receiver 57 of the user PC 50 in step S15.

In step S16, the shaper 55 of the user PC 50 limits the transmission rate so that the rate at which packets are transmitted from the user PC 50 to the edge switch 60 becomes equivalent to the preset band. The shaper 55 also limits the burst allowable amount in accordance with the queue size specified in the band conditions, so as to prevent the queue 61 of the edge switch 60 from overflowing due to short-period burst transmission.

After that, the transmission controller 54 of the user PC 50 transmits the packets, which are stored in the buffer 53, to the edge switch 60, thereby performing communication.

As described above, with the linkup being a trigger, the user PC 50 uses the band negotiation function to limit the amount of packet flow to the edge switch 60. By doing so, the communication rate of the user PC 50 becomes the same as the communication rate of the edge switch 60, and packet discard by the policer 62 of the edge switch 60 is not caused. Also, the queue 61 is prevented from overflowing, and packet discard is not caused here either. As packet discard is not caused in the edge switch 60, the amount of packet retransmission between the user PC 50 and the edge switch 60 under TCP congestion control is reduced, and the usability of the wide area network 10 is increased accordingly.

### Second Embodiment

FIG. 8 shows the operation sequence in accordance with a communication rate control method as a second embodiment of the present invention. Here, the sequence to be carried out after the procedures of steps S11 through S13 of FIG. 7 are carried out is shown.

In FIG. 8, the user PC 50 performs a band negotiation at regular intervals.

In step S20, the band inquirer 56 of the user PC 50 inquires of the edge switch 60 the preset band with respect to the device.

In response to that, the band notifying unit 67 of the edge switch 60 sends the band conditions (the preset band and the queue size) of the user PC 50 to the notification receiver 57 of the user PC 50 in step S21.

In step S22, the shaper 55 of the user PC 50 limits the transmission rate so that the rate at which packets are transmitted from the user PC 50 to the edge switch 60 becomes equivalent to the preset band. The shaper 55 also limits the burst allowable amount in accordance with the queue size specified in the band conditions, so as to prevent the queue 61 of the edge switch 60 from overflowing due to short-period burst transmission.

As described above, a band negotiation from the user PC 50 is performed at regular intervals. By doing so, even if the preset band of the user PC 50 is changed after linkup, the amount of packet flow to the edge switch 60 can be limited in accordance with the latest band conditions. Accordingly, packet discard by the policer 62 of the edge switch 60 is not caused, and the amount of packet retransmission between the user PC 50 and the edge switch 60 under TCP congestion control is reduced. Thus, the usability of the wide area network 10 is increased.

### Third Embodiment

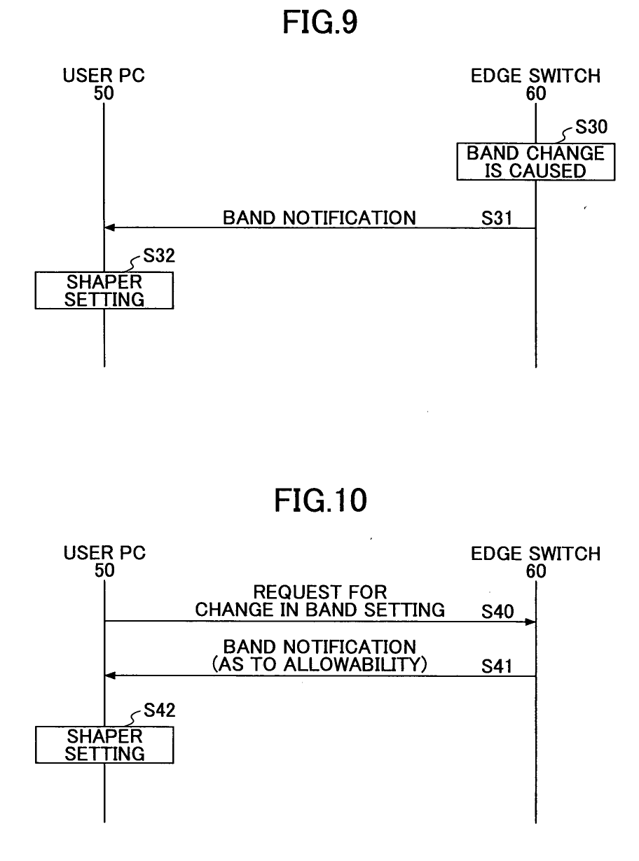

FIG. 9 shows the operation sequence in accordance with a communication rate control method as a third embodiment of the present invention. Here, the sequence to be carried out after the procedures of steps S11 through S13 of FIG. 7 are carried out is shown.

In FIG. 9, the edge switch 60 performs a band negotiation at regular intervals.

In step S30, the preset band of the user PC 50 stored in the memory unit 66 of the edge switch 60 is changed. In step S31, the band notifying unit 67 of the edge switch 60 sends the changed band conditions (the preset band and the queue size) of the user PC 50 to the notification receiver 57 of the user PC 50.

In step S32, the shaper 55 of the user PC 50 limits the transmission rate so that the rate at which packets are transmitted from the user PC 50 to the edge switch 60 becomes equivalent to the preset band. The shaper 55 also limits the burst allowable amount in accordance with the queue size specified in the band conditions, so as to prevent the queue 61 of the edge switch 60 from overflowing due to short-period burst transmission.

As described above, a band negotiation is performed by the edge switch 60, when the preset band of the user PC 50 is changed in the edge switch 60. By doing so, the amount of packet flow to the edge switch 60 can be limited in accordance with the latest band conditions. Accordingly, packet discard by the policer 62 of the edge switch 60 is not caused, and the amount of packet retransmission between the user PC 50 and the edge switch 60 under TCP congestion control is reduced. Thus, the usability of the wide area network 10 is increased.

### Fourth Embodiment

FIG. 10 shows the operation sequence in accordance with a communication rate control method as a fourth embodiment of the present invention. Here, the sequence to be carried out after the procedures of steps S11 through S13 of FIG. 7 are carried out is shown.

In FIG. 10, the user PC 50 requests the edge switch 60 to change the bands, and performs a band negotiation.

In step S40, the band inquirer 56 of the user PC 50 requests the edge switch 60 to change the preset bands.

In response to that, in step S41, the band notifying unit 67 of the edge switch 60 notifies the notification receiver 57 in the user PC 50 of whether the preset band of the user PC 50 can be changed. If the preset band can be changed, the allowed band conditions (the preset band and the queue size) are sent to the notification receiver 57. If the preset band cannot be changed, the previous band conditions are sent to the notification receiver 57.

In step S42, the shaper 55 of the user PC 50 limits the transmission rate so that the rate at which packets are transmitted from the user PC 50 to the edge switch 60 becomes equivalent to the preset band. The shaper 55 also limits the burst allowable amount in accordance with the queue size specified in the band conditions, so as to prevent the queue 61 of the edge switch 60 from overflowing due to short-period burst transmission.

As described above, a band negotiation is performed in response to a band change request from the user PC 50. If a band change is allowed, the amount of packet flow to the edge switch 60 can be limited in accordance with the allowed band conditions. Accordingly, packet discard by the policer 62 of the edge switch 60 is not caused, and the amount of packet retransmission between the user PC 50 and the edge switch 60 under TCP congestion control is reduced. Thus, the usability of the wide area network 10 is increased.

The band inquirer 56 is equivalent to the inquiring unit in claims, the shaper 55 is equivalent to the transmission rate control unit in claims, and the band notifying unit 67 is equivalent to the notifying unit in claims.

It should be noted that the present invention is not limited to the embodiments specifically disclosed above, but other variations and modifications may be made without departing from the scope of the present invention.

This patent application is based on Japanese priority patent application No. 2005-080666, filed on Mar. 18, 2005, the entire contents of which are hereby incorporated by reference.

What is claimed is:

1. A method of controlling a communication rate between a user terminal and an edge switch of a network,
the method comprising the step of:
matching a transmission rate at which data is transmitted from the user terminal to the edge switch, with a communication rate of the edge switch that is determined under contract with a user.

2. The method as claimed in claim 1, wherein the step of matching the transmission rate of the user terminal with the communication rate specified in the user contract is carried out at the time of linkup to connect the user terminal to the network.

3. The method as claimed in claim 1, wherein the step of matching the transmission rate of the user terminal with the communication rate specified in the user contract is carried out at regular intervals.

4. The method as claimed in claim 1, wherein the step of matching the transmission rate of the user terminal with the communication rate specified in the user contract is carried out when the communication rate specified in the user contract with respect to the edge switch is changed.

5. The method as claimed in claim 1, wherein the step of matching the transmission rate of the user terminal with the communication rate specified in the user contract is carried out by the user terminal, when a request to change the transmission rate is made.

6. A user terminal that is used in conjunction with a method of controlling a communication rate between the user terminal and an edge switch of a network,
the user terminal comprising:
an inquiring unit that inquires a communication rate of the edge switch that is determined under contract with a user; and
a transmission rate control unit that matches a transmission rate at which data is transmitted to the edge switch, with the communication rate specified in the user contract that is notified by the edge switch.

7. An edge switch that is used in conjunction with a method of controlling a communication rate between a user terminal and an edge switch of a network,
the edge switch comprising:
a notifying unit that notifies the user terminal of a communication rate that is determined under contract with a user, in response to an inquiry from the user terminal.

8. The user terminal as claimed in claim 6, wherein the inquiring unit makes the inquiry to the edge switch at the time of linkup to connect the user terminal to the network.

9. The user terminal as claimed in claim 6, wherein the inquiring unit makes the inquiry to the edge switch at regular intervals.

10. The edge switch as claimed in claim 7, wherein the notification is sent to the user terminal when the communication rate specified in the user contract is changed.

11. The user terminal as claimed in claim 6, wherein the inquiring unit makes the inquiry to the edge switch when a request to change the transmission rate is made.
